(19) United States
(12) Patent Application Publication
(10) Pub. No.: US 2016/0340242 A1
(43) Pub. Date: Nov. 24, 2016

(54) METHOD FOR CONNECTION OF PARTS COMPOSED OF MATERIALS THAT ARE DIFFICULT TO SOLDER

(71) Applicants: Airbus DS GmbH, Taufkirchen (DE); Airbus Defence and Space GmbH, Muenchen (DE)

(72) Inventors: Catherine Haas, Daisendorf (DE); Tanja Lang, Meersburg (DE); Udo Haberer, Bad Wurzach (DE); Matthias Funke, Markdorf (DE); Christian Wilhelmi, Hoehenkirchen-Siegertsbrunn (DE)

(21) Appl. No.: 15/160,121

(22) Filed: May 20, 2016

(30) Foreign Application Priority Data
May 21, 2015 (EP) 15001526.1

(51) Int. Cl. C03C 27/08; C04B 37/00; C04B 37/04

(52) U.S. Cl. CPC C03C 27/08; C04B 37/045; C04B 37/003

(57) ABSTRACT

A method for connecting a first part, composed of a difficult to solder material, with a second part. A wetting of a first surface of the first part, to be connected with the second part, with a first solder, and connecting the first solder with the first surface of the first part, takes place by introducing heat and ultrasound energy. A wetting of a second surface of the second part, to be connected with the first part, with a second solder takes place. Subsequently, machining of the surface of the first solder is carried out for removal of an oxide layer. Then the first and the second solder covered surfaces are brought into contact with one another, to form a unit. This is followed by exposing the unit to a temperature within a predetermined temperature range, which has an upper temperature limit of less than 800° C.

### CROSS-REFERENCES TO RELATED APPLICATIONS

This application claims the benefit of the European patent application No. 15001526.1 filed on May 21, 2015, the entire disclosures of which are incorporated herein by way of reference.

### BACKGROUND OF THE INVENTION

The invention relates to a method for connecting a first part composed of a material that is difficult to solder, particularly a ceramic, a glass ceramic or a glass, with a second part.

The connection of parts, at least one of which comprises a ceramic material, particularly a monolithic ceramic, or of glass or of a glass ceramic, such as Zerodur, places great demands on the quality of the connection method. These materials represent materials that are difficult to solder.

In general, adhesives are used to connect them. However, the use of adhesives brings with it the problem that the dimensional stability achieved by the bond produced by gluing is not sufficient for producing dimensionally stable structures for space flight applications. Adhesives furthermore demonstrate the disadvantage that they can outgas, and this is also undesirable in space flight applications.

Furthermore, hard soldering methods are known for connecting ceramic materials, for example, that have similar or different material properties. In this regard, temperatures of more than 800° C. are generally required for the connection process. This can result in problems with regard to the thermal expansion coefficient between the solder material used and the ceramic of the connection partners, if the soldering process is not performed correctly.

In order to be able to undertake connection of two parts by means of a soldering method that makes do with lower temperatures, in order to minimize problems on the basis of the effects of thermal expansion coefficients and to keep the stress on the parts to be connected as low as possible, what are called Cerasolzer solders (Cerasolzer, for short) are used. These have a high adhesion capacity to materials that are difficult to solder. The adhesion capacity of a solder connection with Cerasolzer depends, on the one hand, on the properties of the solder alloy. Cerasolzer solders contain small proportions of elements such as Zn, Ti, Si, Al, Be, Sb, and the rare earth metals, which have a good affinity for oxygen. These rare earth metals combine with oxygen during the connection process and form oxides that chemically bond with the surface of glass, ceramic, glass ceramics, etc. On the other hand, the introduction of heat is not enough to achieve wetting of the surface. Aside from heat, the additional introduction of strong ultrasound vibrations therefore takes place. However, the adhesion of the connection of two surfaces wetted with solder does not meet the criteria required for space flight demands.

### SUMMARY OF THE INVENTION

It is an object of the present invention to provide a functionally improved method for the connection of parts, at least one of which comprises a ceramic material or glass or a glass ceramic, which method puts as little structural stress as possible on the parts to be connected, and, at the same time, allows great dimensional stability of the structure produced.

A method for connecting a first part composed of a material that is difficult to solder, particularly a ceramic, a glass ceramic or a glass, with a second part is proposed, wherein the following steps are performed:

a) wetting of a first surface of the first part, to be connected with the second part, with a first solder, and connecting the first solder with the first surface of the first part by introducing heat and ultrasound energy;

b) wetting of a second surface of the second part, to be connected with the first part, with a second solder;

c) machining of the surface of the first solder, to be connected with the second solder, for removal of an oxide layer produced in Step a); optionally, machining of the surface of the second solder, to be connected with the first solder, can also be performed, in order to remove an oxide layer produced in Step b);

d) producing a connection of the first surface of the first part, wetted with the first solder, and of the second surface of the second part, wetted with the second solder, by means of bringing the first and the second surface into contact with one another to form a unit;

e) performing a temperature step in which the unit is exposed to a temperature within a predetermined temperature range, which has a lower temperature limit and an upper temperature limit, wherein the upper temperature limit is less than 800° C.

A part composed of a material that is difficult to solder, particularly a ceramic, preferably a monolithic ceramic such as silicon carbide, silicon nitride or aluminum nitride, a glass ceramic such as Zerodur or a glass, may be processed, at least as the first part. Optionally, a part composed of one of the aforementioned materials that are difficult to solder may also be processed as a second part.

A monolithic ceramic composed of silicon carbide (SiC), a chemical compound of silicon and carbon, which belongs to the group of carbides may be used, for example. Silicon carbide demonstrates great rigidity and hardness, as well as low thermal expansion. Silicon carbide furthermore demonstrates great chemical and thermal stability. The mechanical properties with regard to bending resistance and ductility hardly change with the temperature. Likewise, silicon nitride may be used as a monolithic ceramic. Silicon nitride is a chemical compound that comprises the elements silicon and nitrogen, with the formula Si3N4. It has great strength, in comparison with silicon carbide, and, for monolithic ceramics, great ductility, a low heat expansion coefficient, and a comparatively small modulus of elasticity, and is therefore particularly well suited for components subject to thermal shock stress. Likewise, Zerodur may be used as the material of the first part, and optionally of the second part. Zerodur is a glass ceramic material that is produced by means of controlled volume crystallization. Zerodur contains a crystalline phase and a residual glass phase, by means which phases an extremely low expansion coefficient, good material homogeneity, chemical resistance, and mechanical properties that vary only slightly are achieved.

The present method for connecting the first and of the second part does not make use of the technology of hard soldering (called brazing), but instead uses the method of soft soldering, in which fewer stresses are introduced into the connection partners, i.e., the first and the second part, because of the significantly lower temperatures.

These materials, which as such cannot be connected by means of soft soldering, or can only be connected with difficulty, become connectable by means of soldering, since at least in Step a) the production of the connection of the first solder with the first part takes place, by introducing heat and ultrasound energy, thereby making good adhesion between the first part and the first solder possible. In the event that the second part also comprises a material that is difficult to solder, production of the connection of the second solder with the second part takes place in corresponding manner, by introducing heat and ultrasound in Step b), as well.

In this manner, the first and optionally the second surface of the first or second part, respectively, composed of ceramic or Zerodur, is tin-plated, so that in the subsequent temperature step, a solder connection of the two surfaces can occur. For the benefit of a planar or impurity-free solder connection between the first and the second solder, and for the benefit of it to have the required adhesion properties, removal of the oxide layers that form on their own during wetting of the first and optionally second solder with the respective first and second surface of the first and second part may take place. Machining of the respective surface of the first and/or second solder to remove the oxide layer produced in Step a) or b) may take place by means of grinding or milling, for example. Of course, other removal methods are also possible.

An advantage of the method of procedure described comprises that hard soldering (brazing) connected with high temperatures of more than 800° C. can be avoided. As a result, lower thermal tensions are introduced into the region of the connection surface. For smaller parts and non-structural connections, particularly when using the connected part as a space flight component, a highly effective connection method can be made available in this way. In this regard, the connection structure, i.e., the unit formed from the first and the second part, demonstrates significantly better dimensional stability as compared with a connection using adhesives.

According to a practical embodiment, a solder that contains components of one or more rare earth metals may be used as the first and/or as the second solder. For example, Cerasolzer, also called Cerasolzer solder, may be used as the first and/or as the second solder. Cerasolzer is known from the production of electronic components, in order to contact electrical materials or to contact glass or metallized glass types. Cerasolzer is a eutectic solder that is free of flux, corrosion-free, and can be processed at temperatures between 150° C. and 300° C. It has wetting properties that are suitable for glass, glass ceramics, and ceramics.

As was described initially, it is advantageous to work with the lowest possible temperatures in the connection process of the first and second part. For this reason, it is advantageous if Step a) is carried out at temperatures of less than 300° C., particularly less than 260° C., and further preferably less than 200° C. This temperature range can be achieved by means of selection of a suitable solder.

It is furthermore advantageous if in Step a) and optionally b), the first and optionally the second solder is melted on the first or second surface, respectively, and the melted solder is brought into adhesion with the material of the first and second part, respectively, for example, using an ultrasound solder gun, causing respective oxide layers to be removed from the first and second surface by means of ultrasound. What is called the “Ultrasonic Cavitation Phenomenon” is utilized for removal of the respective oxide layers, by means of which oxidized layers on the first and second surface may be removed in a simple manner and, at the same time, the surfaces are cleaned. Micro-vibrations are produced during this process, by means of an intensive ultrasound bundle, which vibrations have a brushing effect that makes complete removal of the oxide layer possible for direct wetting with the solder. This results in the advantage that no kind of flux is required when the solder is applied to the first or second surface. As a result, in combination with the tin plating described above, soft soldering of aluminum, glass, ceramics, metals that are difficult to solder (such as stainless steel, titanium, metal oxides) is made possible in simple manner

It may furthermore be advantageous if previous heating of the first part or of the second part takes place before the step of introducing heat and ultrasound energy for connection of the first solder with the first part and optionally of the second solder with the second part. This may be implemented, for example, by means of a temperature-adjustable heating plate.

For producing the connection in Step d), it is advantageous if the first and the second part are oriented plane-parallel with reference to their first and second surface, before the first and the second surface are pressed against one another with a force in a predetermined force range, particularly 0.05 N/mm2 to 0.5 N/mm2. This may take place using a processing device, for example. Furthermore, it is possible to apply a uniform force to the first and the second surface, over their entire contact surface, using the processing device. In this way, the reliability of the mechanical connection between the first and the second part can be optimized.

It is furthermore advantageous if a ductile material is introduced between the first and the second surface as a spacer, by means of which a predetermined distance, particularly between 0.1 mm and 0.3 mm, between the first and the second surface is produced after solidification of the first and the second solder. In this way, the strength and plane-parallelity of the connection can be optimized.

According to a first embodiment variant, in Step e) the step of vapor phase soldering (sometimes also called condensation soldering method) may be carried out. For this purpose, the unit composed of the first and second part connected with one another may be introduced into a vapor phase soldering apparatus, which utilizes the condensation heat released during the phase change of a heat transfer medium from the gaseous to the liquid state for heating the unit. In this regard, condensation takes place at the surface of the unit, until the entire unit has reached the temperature of the vapor. When the liquid (the heat transfer medium) boils, a saturated, chemically inert vapor zone forms above it, the temperature of which is identical, to a great extent, to the boiling point of the liquid, so that an optimal inert atmosphere is formed and oxidations during the vapor phase soldering process are excluded. Perfluoropolyether (PFPE), for example, may be used as the heat transfer medium. The heat transfer in a vapor phase soldering apparatus is fast and independent of geometry. In particular, no cold zones occur in the shadow of larger components. No overheating of the components is possible because of the precisely defined soldering temperature and the uniform heating.

According to another embodiment variant, the first and the second surface may be locally exposed to the temperature in Step e). For this purpose, a reactive auxiliary layer, which experiences a self-maintaining exothermic reaction after controlled activation, may be introduced between the first and the second surface in a Step c1) that is carried out after Step c) and before Step d), so that in Step d), the first and the second surface are connected with the auxiliary layer.

In Step e), activation of the auxiliary layer by means of the introduction of energy may then take place, thereby causing materials of the auxiliary layer to react chemically and, on the basis of their reaction, to generate thermal energy for melting the first and the second solder. Because the thermal energy is generated by the auxiliary layer, merely local heating of the first and of the second solder then takes place, thereby guaranteeing a particularly gentle connection process with regard to the introduction of temperature. Activation of the auxiliary layer by means of the introduction of energy may take place optically, electrically or thermally.

The auxiliary layer may comprise aluminum as a first material and nickel as a second material. Such an auxiliary layer is known under the name NanoFoil, for example.

### BRIEF DESCRIPTION OF THE DRAWINGS

The invention will be explained in greater detail below, using the description of exemplary embodiments in the drawing:

FIG. 1 shows a schematic representation of two parts disposed one on top of the other, on the surfaces of which a solder has been applied by means of a soft soldering method, in preparation, which surfaces are to be connected,

FIG. 2 shows a processing apparatus by means of which a connection of the tin-plated parts to be connected is made possible,

FIG. 3 shows a schematic representation of a vapor phase soldering apparatus, and

FIGS. 4a-4d show consecutive processing steps for the production of a connection of parts composed of a material that cannot be soldered, by means of soft soldering.

### DETAILED DESCRIPTION OF THE PREFERRED EMBODIMENTS

FIG. 1 shows a schematic representation of two parts 10, 20 that are to be connected with one another. For the sake of simplicity, the first and the second part 10, 20 are structured as flat elements. It is understood, however, that the method described here can also be used for shapes that are configured to be more complex.

Preferably, the method described below is used for the production of space flight components that are subject to great demands with regard to dimensional stability and permanent quality of the connection. For the reasons stated, the first and the second part generally comprise ceramic or glass ceramic materials, such as, for example, monolithic ceramics or Zerodur® ceramic. Fundamentally, however, the method is suitable for connection even if only one of the two parts comprises a ceramic material. A monolithic ceramic or Zerodur ceramic has the property of being inherently difficult to process by means of soft soldering methods. But since the soft soldering method can be carried out at significantly lower temperatures, as compared with hard soldering, and thereby at lower stresses for the connection partners, the method described below was developed, with which parts comprising ceramic can be connected by means of a soft soldering method.

Silicon carbide (SiC) or silicon nitrides (Si3N4), for example, are used as ceramics for the first and/or the second part. The first and/or the second part 10, 20 may alternatively comprise Zerodur ceramic.

As is shown schematically in FIG. 1, the first and the second part 10, 20 are supposed to be connected with one another in the region of a first surface 11 of the first part 10 and a second surface 21 of the second part 20. To carry out a soft soldering process, tin plating of the first and of the second surface 11, 21 takes place. For this purpose, a first solder 12 is applied to the first surface 11, and a second solder 22, having a proportion of rare earth metals, for example Cerasolzer, is applied to the second surface; they are melted and connected with the first surface 11 and the second surface 21, respectively, by means of the introduction of ultrasound energy. Melting of the first and second solder 12, 22 takes place at temperatures between 150° C. and 300° C., depending on the solder selected. It is advantageous if the solder is selected in such a manner that melting is possible at a temperature of less than 300° C., particularly less than 260° C., and further preferably less than 200° C., with the temperature being determined by the solder being used.

During application and melting of the solder 12, 22 onto the first and second surface 11, 21, removal of any oxide layers on the first or second surface 11, 21 takes place, in that micro-vibrations are produced by means of an intensive ultrasound bundle and a brushing effect is achieved. After removal of the oxide layer, the solder 12, 22 can connect with the first or second surface 11, 21 of the first or second part 10, 20. Also on this basis, the use of an additional flux is not necessary.

In order for the solder connection between the first and the second solder 12, 22 to have the required adhesion properties, removal of oxide layers that form during wetting of the first and second solder 12, 22 with the respective first and second surface 11, 21 of the first and second part 10, 20, on the surfaces of the first and second solder 12, 22 themselves takes place. Machining of the respective surface of the first and/or second solder to remove the oxide layers may take place, particularly after the first and/or second solder has solidified, by means of grinding or milling, for example, thereby creating a plane-parallel surface for the subsequent connection process of the solders 12, 22, at the same time.

In order to ensure a uniform distance of the parts 10, 20, after connection and cooling, between 0.1 mm and 0.3 mm, a ductile material may be introduced between the first and the second part 10, 20 as a spacer. In this way, a plane-parallel connection between the parts 10, 20 during the soldering process, in particular, is ensured, and this ensures a planar connection, free of impurities.

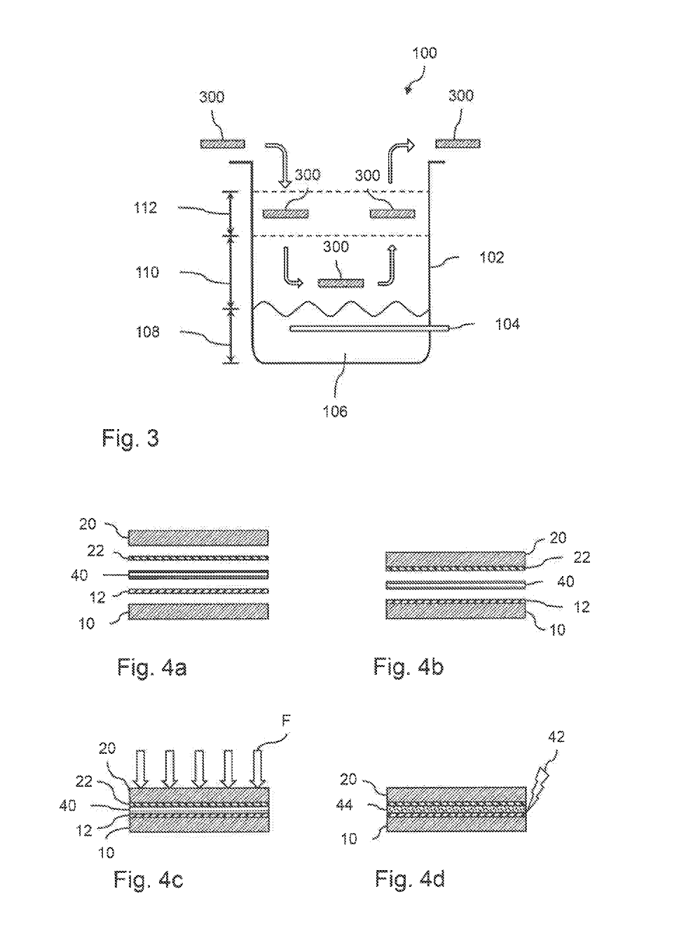

Subsequently, the production of a connection in the region of the first and the second surface 11, 21 takes place. For this purpose, a processing device 300 as shown schematically in FIG. 3 is preferably used, so that a plane-parallel connection between the first and the second part 10, 20 and a uniform pressure application over the entire connection are made possible.

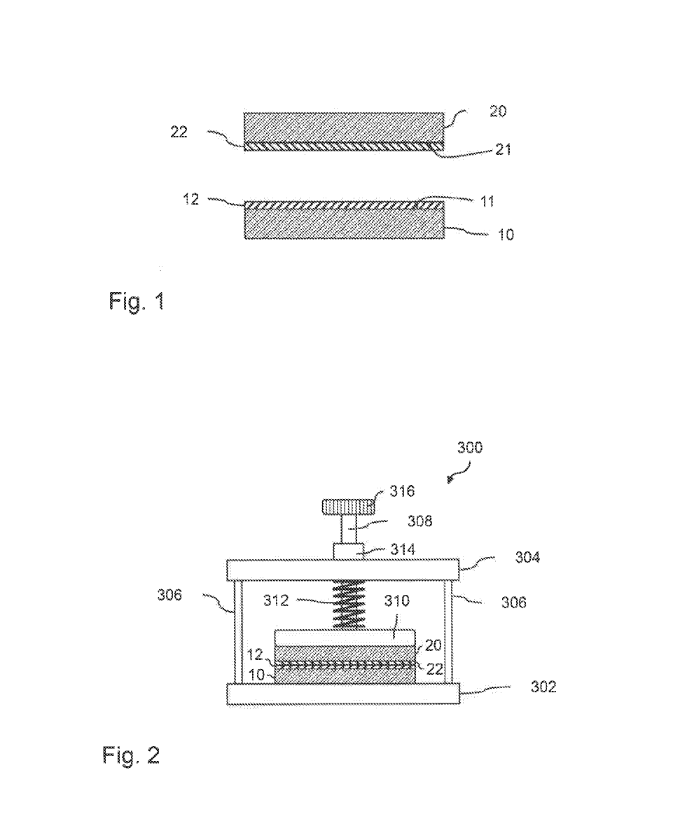

The processing device 300, which is shown schematically in FIG. 2, comprises a base plate 302 that is connected with a cover plate 304 disposed in plane-parallel manner, by way of two or more connection supports 306. The first part 10 is laid onto the base plate 302 with the side not to be connected (i.e., the side that lies opposite the first surface). As a result, the first surface 11 to be connected faces in the direction of the cover plate 304. The second part 20 is laid onto the latter, with its second surface 21 facing in the direction of the first part 10. A pressure plate 310, which, for practical purposes, has at least one surface that corresponds to the surface to be connected, borders on the back side of the second part 20. The pressure plate 310 is mechanically connected with a shaft 308 that projects through the cover plate 304 and can be displaced in the axial direction. A spring element 312 is disposed between the pressure plate 310 and the cover plate 304. In this regard, the spring element 312 presses the pressure plate 310 uniformly against the second part 20, so that a uniform force is achieved in the region of the first and second surface 11, 21 to be connected. A locking element 314 that surrounds the shaft 308 makes it possible to remove the pressure plate 310 from the second plate 20 by pulling on an engagement element 316, and thereby to hold the shaft 308 counter to the spring force, so that no force acting in the direction of the base plate 302 can be exerted on the unit 30 by the pressure plate 310. As a result, the unit 30 can be removed from the processing device and new parts 10, 20 can be laid into the processing device.

The unit prepared in this manner, which is subsequently provided with the reference symbol 30, can be introduced into a vapor phase soldering apparatus 100, as shown in FIG. 3, together with the processing device 300. After having passed through the vapor phase soldering apparatus 100, the first and the second solder layer 12, 22 are connected with one another with material fit.

FIG. 3 shows a fundamentally known vapor phase soldering apparatus 100, which is used to subject a unit 30 prepared in the processing device 300 to a temperature step for carrying out the soft soldering process. The vapor phase soldering apparatus 100 comprises a container 102, for example composed of a non-rusting stainless steel. A chemically inert liquid 106 is in the container 102 as a heat transfer medium. In this regard, the chemically inert liquid 106 takes up a first region 108 in the height direction of the container 102. The chemically inert liquid 106 is brought to a boil by a heating element 104, which is completely surrounded by the chemically inert liquid 106. As a result, a second region of a primary vapor layer, indicated with 110, forms. Lying above that is a third region 112, which forms a secondary vapor layer. Perfluoropolyether (PFPE) can be used as the heat transfer medium. The vapor phase soldering apparatus 100 utilizes the condensation heat released during the phase change of the heat transfer medium 106 from the gaseous to the liquid state to heat the unit 30, which is still disposed in the processing device 300. In this regard, condensation takes place at the surface of the unit 30 until the entire unit has reached the temperature of the vapor.

If the unit 30 is now introduced, together with the processing device 300, as shown in FIG. 2, into the primary vapor layer of the second region 110, by way of the secondary vapor layer of the third region 112, for a predetermined period of time, during which the heat transfer medium (the chemically inert liquid 106) is present in the gaseous state, the temperature of which is essentially identical to the boiling point of the chemically inert liquid 106, then fast and geometry-independent heat transfer to the unit 30 takes place. As a result, the unit 30 and the solder layer 12, 22 have a precisely defined soldering temperature applied to them, which depends on the liquid or the selected heat transfer medium. At the same time, it is ensured that the unit 30 heats up uniformly and no overheating of the components takes place. At the same time, as long as the unit 30 is situated in the second region 110, an optimal protective atmosphere has formed, so that oxidations in the vapor phase soldering process can be excluded. Furthermore, the demand for preheating zones is lower. After the unit 30 has been removed from the container, the solder layers have been connected with one another. Subsequently, the unit 30 can also be removed from the processing device 300.

FIGS. 4a-4d show an alternative embodiment, in which heating of the solder layers 12, 22 is implemented using an auxiliary layer 40 disposed between the solder layers 12, 22. A reactive multi-layer foil, such as one called NanoFoil®, composed of a plurality of aluminum and nickel layers, for example, can be used as an auxiliary layer 40. FIG. 4a shows the sequence in which the first part 10, the first solder 12, the auxiliary layer 40, the second solder 22, and the second part 20 are disposed one on top of the other and connected. According to FIG. 4b, as has already been described, the first solder 12 is first applied to the first surface 11 of the first part 10 by means of the introduction of ultrasound. In a corresponding manner, the second solder 22 is applied to the second surface 21 of the second part 20 by means of the introduction of heat and ultrasound. The surfaces of the first solder layer 12 and of the second solder layer 22, which are connected with the layer sequence 40, are furthermore made flat, smooth, and clean by means of a suitable processing process, thereby causing the undesirable oxide layers 12, 22 to be removed. The first and second parts 10, 20 prepared in this manner are disposed to lie opposite one another, with their solder layers 12, 22 facing one another. The auxiliary layer 40 is provided between them.

According to FIG. 4c, the layer sequence prepared in this manner has a force F applied to it. The force F that is exerted should be selected in such a manner that the melted solder 12, 22 flows and sufficiently wets the component surfaces. The force preferably lies in a force range between 0.05 N/mm2 and 0.5 N/mm2. After this step, which ensures uniform wetting of the surfaces 11, 21, activation of the layer sequence 40 takes place by means of the introduction of optical, electrical or thermal energy, thereby causing the layer sequence 40 to react chemically and to generate thermal energy for melting the first and second solder 12, 22, on the basis of its exothermic reaction. The heating process and the cooling take place so rapidly, in this connection, that only part of the solder thickness is melted, and when the solder layers formed by removal of the oxide layers have a uniform thickness, the final distance between the parts 10, 20 also comes out to be uniform.

As has been described, a reactive multi-layer foil, such as one called NanoFoil, may be used as an auxiliary layer, for example; this comprises thousands of what are called nano-layers composed of aluminum and nickel, which react exothermically after the reaction has been started with an energy pulse. The thermal reaction that has been triggered after activation serves as a fast and controllable local heat source, which melts the adjacent solder layers 12, 22 and thereby produces a connection of the components. This process is known under the name NanoBond®. In this regard, heat generation occurs so quickly that only the solder layers 12, 22 that border on the auxiliary layer 40 experience the introduction of heat.

A connection produced in this manner demonstrates great reliability. In particular, great dimensional stability exists, so that the method is particularly well suited for the production of space flight components.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SYMBOL LIST

10 first part
11 first surface
12 first solder
20 second part
21 second surface
22 second solder
30 unit composed of first part and second part
40 auxiliary layer
42 activation energy
44 activated auxiliary layer
100 vapor phase soldering apparatus
102 container (composed of stainless steel)
104 heating element
106 chemically inert liquid
108 first region with boiling inert liquid
110 second region (primary vapor layer)
112 third region (secondary vapor layer)
300 processing device
302 base plate
304 cover plate
306 connection supports
308 shaft
310 pressure plate
312 spring
314 locking device
316 engagement element

1. A method for connecting a first part composed of a material that is difficult to solder with a second part, wherein the following steps are performed:
a) wetting of a first surface of the first part, to be connected with the second part, with a first solder, and connecting the first solder with the first surface of the first part by introducing heat and ultrasound energy;
b) wetting of a second surface of the second part, to be connected with the first part, with a second solder;
c) machining of the surface of the first solder, to be connected with the second solder, for removal of an oxide layer produced in Step a);
d) producing a connection of the first surface of the first part, wetted with the first solder, and of the second surface of the second part, wetted with the second solder, by bringing the first and the second surface into contact with one another to form a unit;
e) performing a temperature step in which the unit is exposed to a temperature within a predetermined temperature range, which has a lower temperature limit and an upper temperature limit, wherein the upper temperature limit is less than 800° C.

2. The method according to claim 1, wherein in Step c), machining of the surface of the second solder, to be connected with the first solder, is additionally performed for removal of an oxide layer produced in Step b).

3. The method according to claim 1, wherein a part composed of a material that is difficult to solder is provided as the second part, wherein in Step b), a connection of the second solder with the second surface of the second part takes place by introducing heat and ultrasound energy.

4. The method according to claim 1, wherein the machining of the surface of the first solder for removal of the oxide layer produced in Step a) takes place by means of grinding or milling

5. The method according to claim 1, wherein a solder that contains components of one or more rare earth metals is used as at least one of the first and second solders.

6. The method according to claim 1, wherein Step a) is carried out at temperatures of less than 300° C.,

7. The method according to claim 1, wherein Step a) is carried out at temperatures of less than 200° C.

8. The method according to claim 1, wherein in Step a) the first solder is melted on the first surface, and the melted solder is brought into adhesion with the material of the first part, wherein oxide layers on the first surface are removed by means of ultrasound.

9. The method according to claim 1, wherein in Step d), producing the connection, the first surface of the first part and the second surface of the second part are oriented plane-parallel to one another before the first and the second surface are pressed against one another with a force in a predetermined force range,

10. The method according to claim 9, wherein the predetermined force range is 0.05 N/mm2 to 0.5 N/mm2.

11. The method according to claim 9, wherein a ductile material is introduced between the first and the second surface as a spacer, by means of which a predetermined distance between the first and the second surface is produced after solidification of the first and the second solder.

12. The method according to claim 11, wherein the predetermined distance is in the range of between 0.1 mm and 0.3 mm

13. The method according claim 1, wherein in Step e), the step of vapor phase soldering is carried out.

14. The method according to claim 1, wherein in Step e), the first and the second surface are locally exposed to the temperature.

15. The method according to claim 14, wherein in a Step c1), which is carried out after Step c) and before Step d), a reactive auxiliary layer, which experiences a self-maintaining exothermic reaction after controlled activation, is introduced between the first and the second surface, so that in Step d), the first and the second surface are connected with the auxiliary layer.

16. The method according to claim 15, wherein in Step e), activation of the auxiliary layer by introducing energy takes place, thereby causing materials of the auxiliary layer to react chemically and, on the basis of their reaction, thermal energy for melting the first and the second solder is generated.

17. The method according to claim 16, wherein the activation takes place one of optically, electrically or thermally.

18. The method according to claim 15, wherein the auxiliary layer comprises aluminum as the first material and nickel as the second material.

19. The method according to claim 15, wherein a reactive multi-layer foil is used as the auxiliary layer.

20. The method according to claim 1, wherein the material of the first part is at least one of a ceramic, a glass ceramic or a glass.
